(19) United States
(12) Patent Application Publication
(10) Pub. No.: US 2025/0389900 A1
(43) Pub. Date: Dec. 25, 2025

(54) FIBER OPTIC CONNECTOR

(71) Applicant: ACON OPTICS COMMUNICATIONS INC., New Taipei City (TW)

(72) Inventor: Rui Zhang, New Taipei City (TW)

(21) Appl. No.: 19/179,494

(22) Filed: Apr. 15, 2025

(30) Foreign Application Priority Data
Apr. 18, 2024 (TW) 113203862

(51) Int. Cl. G02B 6/38

(52) U.S. Cl. CPC G02B 6/3825; G02B 6/3831

(57) ABSTRACT

A fiber optic connector is connected to a fiber optic adaptor having an optical signal transmission device and includes a metallic connector housing, a metallic pressing member, and an optical fiber unit. The metallic connector housing defines a mounting space. At least one positioning pillar is disposed in the mounting space. At least one spring member is mounted on the at least one positioning pillar. The metallic pressing member is mounted in the mounting space and presses the at least one spring member. The metallic pressing member is provided with at least one locking portion. When the metallic pressing member is pushed, the at least one locking portion is moved to a position where the fiber optic adaptor is unlocked. The optical fiber unit is secured to the metallic connector housing, and is connected to the optical signal transmission device.

### CROSS-REFERENCE TO RELATED APPLICATION

This non-provisional application claims priority under 35 U.S.C. § 119 (a) to patent application Ser. No. 11/320,3862 filed in Taiwan R.O.C. on Apr. 18, 2024, the entire contents of which are hereby incorporated by reference.

### FIELD OF THE INVENTION

The instant disclosure relates to a connector and, more particularly, to a fiber optic connector or an optical fiber connector.

### BACKGROUND

A fiber optic connector is usually used in a machine that operated in a high temperature environment over extended periods. In addition, the machine comprises multiple optical fiber connectors which are densely arranged and are close to each other, so that there is leaving no space for heat dissipation once a large number of densely packed optical fiber connectors are installed. However, the conventional fiber optic connector is made of plastic material making the conventional fiber optic prone to deformation under prolonged high temperatures during a long-term utilization, thereby easily causing an unstable optical fiber contact.

### SUMMARY OF THE INVENTION

The instant disclosure is to provide a fiber optic connector capable of operating reliably in high temperature environments.

In view of these, an embodiment of the instant disclosure provides a fiber optic connector that is connectable to a fiber optic adapter incorporating an optical signal transmission device. The fiber optic connector comprises a metallic connector housing, a metallic pressing member assembled with or mounted on the metallic connector housing, and an optical fiber unit received and mounted on the metallic connector housing. The metallic connector housing has an upper portion that defines a mounting space. At least one positioning pillar is disposed in the mounting space. At least one spring member is mounted and positioned on the at least one positioning pillar. The metallic pressing member is mounted in the mounting space and presses the at least one spring member. The metallic pressing member is provided with at least one locking portion. Thus, when the metallic pressing member is pushed, the at least one locking portion is moved from a first position (an upper position), in which the fiber optic adaptor is locked to, a second position (a lower position) in which the fiber optic adaptor is unlocked. The optical fiber unit is mounted on and secured to the metallic connector housing, and is connected to the optical signal transmission device along an axial direction.

In one embodiment, the mounting space is defined by two short walls and two long walls formed on the top of the metallic connector housing. The two long walls connect the two short walls.

In one embodiment, each of the two long walls has an inside formed with at least one guide portion directed toward the mounting space.

In one embodiment, the metallic pressing member has two sides each formed with at least one guide slot aligning with the at least one guide portion. The at least one guide slot guides and limits the at least one guide portion.

In one embodiment, each of the two long walls has a periphery formed with at least one limit groove and at least one opening. The at least one opening aligns with and allows operation of the at least one locking portion.

In one embodiment, the metallic pressing member has two sides each formed with at least one limit piece aligning with the at least one limit groove. Thus, the at least one limit piece is restricted by the at least one limit groove to prevent the metallic pressing member from being detached from the metallic connector housing.

According to some embodiments of the instant disclosure, the metallic pressing member is mounted in the mounting space of the metallic connector housing and presses the at least one spring member. The user only needs to press the metallic pressing member to compress the at least one spring member and to unlock the fiber optic adaptor. Thus, the fiber optic connector is provided with the metallic connector housing and the metallic pressing member, so that the fiber optic connector is available for a machine that is operated under a high temperature environment. In addition, the fiber optic connector has an enhanced structural strength and will not be deformed.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE SEVERAL VIEWS OF THE DRAWING(S)

The instant disclosure will become more fully understood from the detailed description given herein below for illustration only, and thus not limitative of the instant disclosure, wherein:

FIG. 1 is a perspective view of a fiber optic connector according to an exemplary embodiment of the instant disclosure;

FIG. 2 is an exploded perspective view of the fiber optic connector according to an exemplary embodiment of the instant disclosure;

FIG. 3 is a top view of the fiber optic connector according to an exemplary embodiment of the instant disclosure;

FIG. 4 is a side cross-sectional view of the fiber optic connector according to an exemplary embodiment of the instant disclosure;

FIG. 5 is a schematic side view showing the fiber optic connector before being pressed; and

FIG. 6 is a schematic side view showing the fiber optic connector after being pressed.

### DETAILED DESCRIPTION

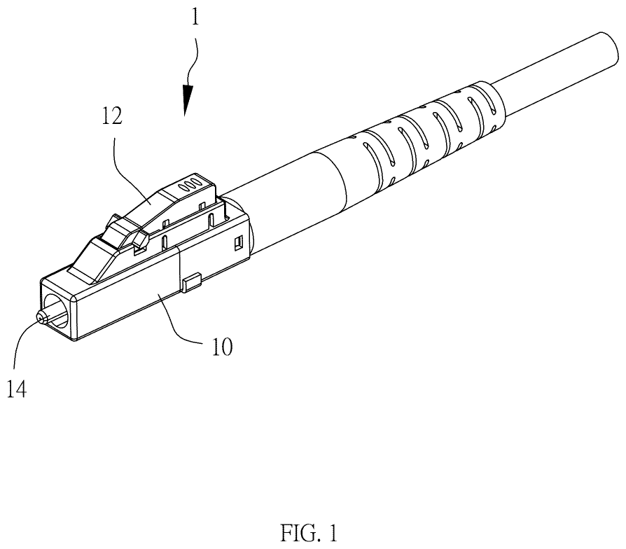

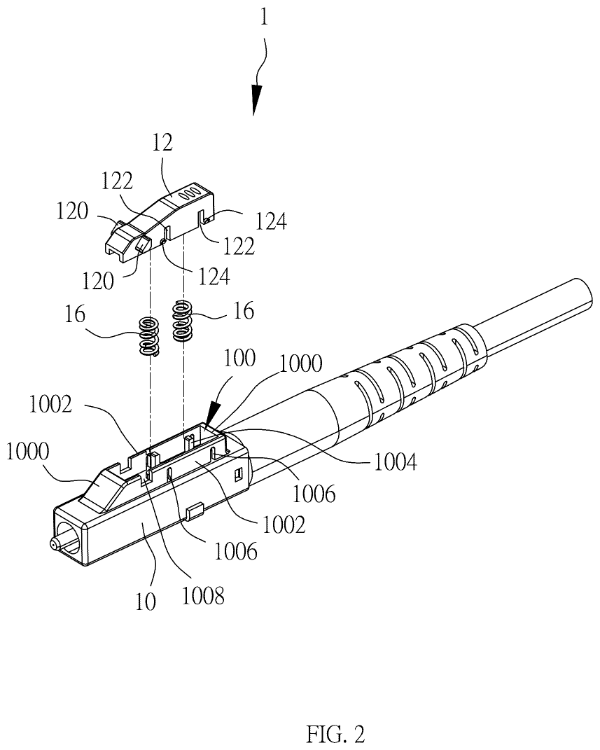

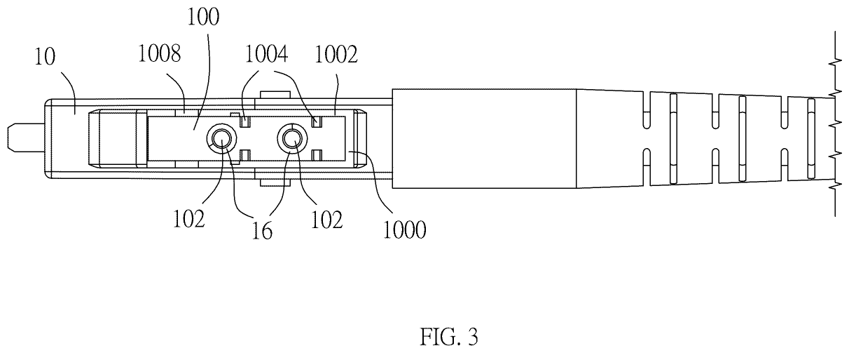

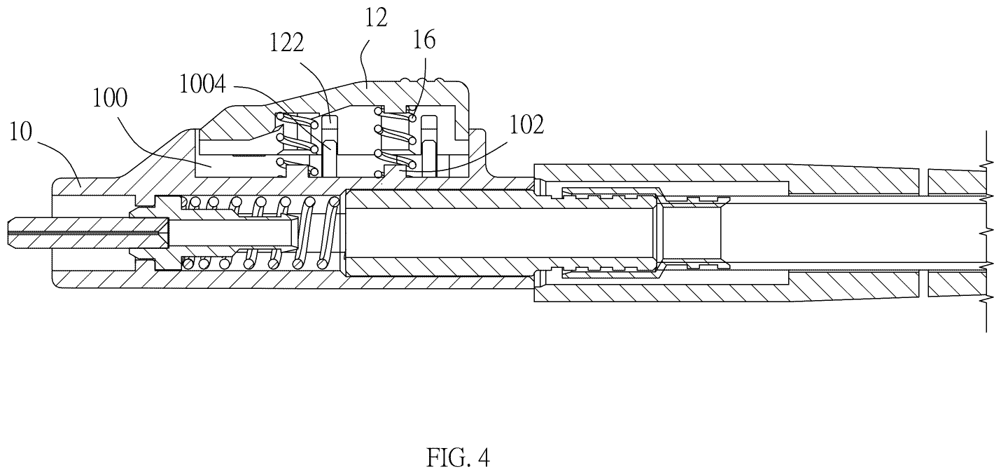

Referring to the drawings and initially to FIGS. 1-5, a fiber optic connector 1 of an exemplary embodiment according to the instant disclosure is connected to a fiber optic adaptor that includes an optical signal transmission device.

The fiber optic connector 1 comprises a metallic connector housing (or metallic connector device) 10, a metallic pressing member 12 mounted on or assembled with the metallic connector housing 10, and an optical fiber unit (or ferrule) 14 received in and secured to the metallic connector housing 10.

The metallic connector housing 10 includes an upper portion that defines a mounting space 100. At least one positioning pillar 102 is disposed in the mounting space 100. At least one spring member 16 is mounted or assembled and positioned on the at least one positioning pillar 102. The metallic pressing member 12 is mounted or assembled in the mounting space 100 and presses the at least one spring member 16.

The metallic pressing member 12 includes two locking portions 120. The two locking portions 120 are respectively located at two lateral sides of the metallic pressing member 12. Thus, when the metallic pressing member 12 is pushed, the two locking portions 120 are moved from a first position (an upper position), in which the fiber optic adaptor is locked to, a second position (a lower position) in which the fiber optic adaptor is unlocked.

The optical fiber unit 14 is received and secured to the metallic connector housing 10, and is connected to the optical signal transmission device along an axial direction.

It is evident that the metallic connector housing 10 and the metallic pressing member 12 are made of metallic material, which result in superior overall strength and a higher melting point compared to conventional optical fiber connectors formed of plastic material. Typically, optical fiber connectors are used in high-temperature environment. Furthermore, these optical fiber connectors are often densely arranged in close proximity to one another, leaving insufficient space for heat dissipation. As a result, conventional optical fiber connectors are prone to deformation under high temperatures, leading to unstable optical contact. In contrast, the fiber optic connector 1 of the instant disclosure adopts the metallic connector housing 10 and the metallic pressing member 12 to effectively overcome the above-mentioned problems.

In this embodiment, the mounting space 100 is defined by two short walls 1000 and two long walls 1002, which are formed on the upper portion of the metallic connector housing 10. The two long walls 1002 connect the two short walls 1000.

In this embodiment, an inner surface of each of the two long walls 1002 is formed with at least one guide portion 1004 extending toward the metallic pressing member 12.

In this embodiment, the metallic pressing member 12 has two sides, each formed with at least one guide slot 122 that aligns with and is mounted onto the corresponding guide portion 1004. The guide slot 122 engages with and constrains the movement of the guide portion 1004.

In this embodiment, each of the two long walls 1002 is formed with multiple guide portions 1004, and each of the two side of the metallic pressing member 12 is formed with multiple guide slots 122 slidably mounted on the corresponding guide portions 1004. Each of the guide portions 1004 is configured as a protruding block. Thus, the metallic pressing member 12 is stably mounted within the mounting space 100 through the engagement between the guide portions 1004 and guide slots 122, enabling even distribution of applied force and preventing deflection of metallic pressing member 12 during movement.

In this embodiment, each of the two long walls 1002 has a periphery formed with at least one limit groove 1006 and two openings 1008. Each opening 1008 is aligned with and allows movement of the corresponding locking portion 120. Thus, when the metallic pressing member 12 is actuated and pushed, the locking portion 120 moves into the corresponding opening 1008.

In this embodiment, each of the two sides of the metallic pressing member 12 is formed with at least one limit (or anti-detachment) piece 124, which aligns with the corresponding limit groove 1006. The limit piece 124 is confined within the limit groove 1006, thereby preventing detachment of the metallic pressing member 12 from the metallic connector housing 10.

In this embodiment, each of the two long walls 1002 is formed with multiple limit grooves 1006, and each of the two sides of the metallic pressing member 12 is formed with multiple limit pieces 124 slidably engaged with the limit grooves 1006. This arrangement ensures that the metallic pressing member 12 remains stable and does not be jammed during operation.

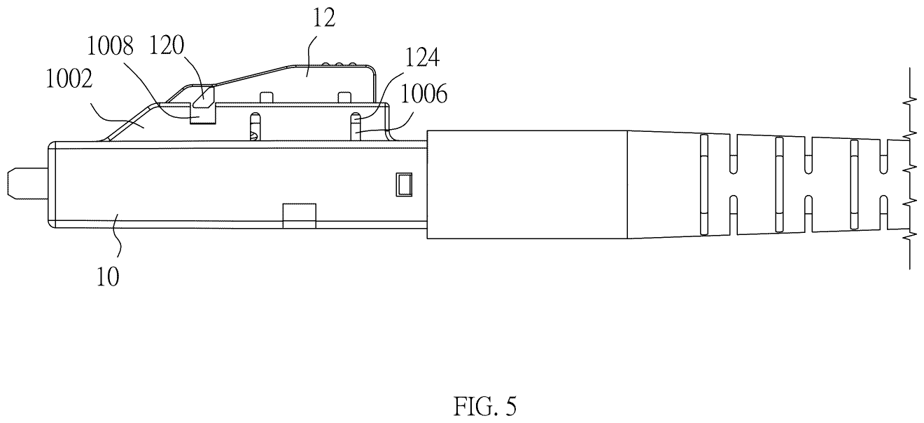

Referring to FIG. 5 with reference to FIGS. 1-4, the metallic pressing member 12 is pushed by the at least one spring member 16 toward a raised (or upper) position. In this position, the at least one limit piece 124 is confined by the corresponding limit groove 1006, thereby preventing the metallic pressing member 12 from detaching from the metallic connector housing 10. In addition, the two locking portions 120 are respectively positioned above the corresponding openings 1008, such that the at least one locking portion 120 is engaged with and locked into the fiber optic adaptor.

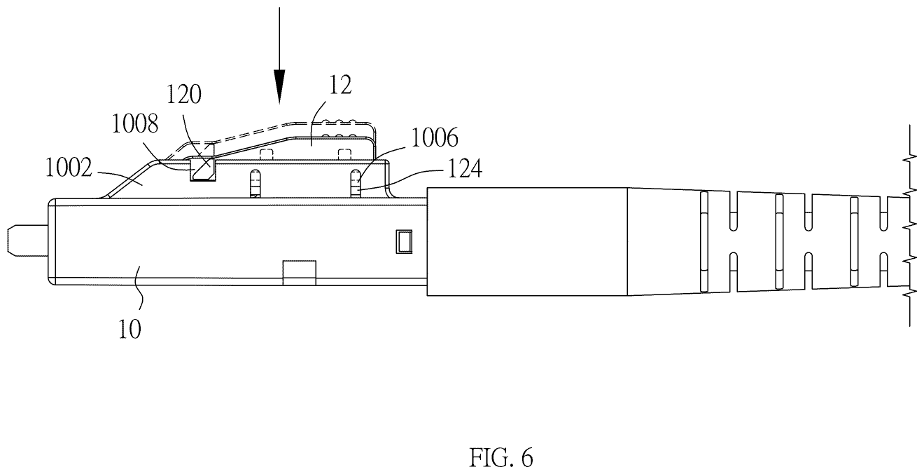

Referring to FIG. 6 with reference to FIGS. 1-5, when the metallic pressing member 12 is pressed downward, the at least one spring member 16 is compressed, causing the at least one locking portion 120 is moved into the at least one opening 1008 and disengage from the fiber optic adaptor, thereby unlocking the fiber optic adaptor. During this movement, the at least one guide slot 122 slides along and is guided by the at least one guide portion 1004, which ensures that the applied force is evenly distributed and prevents the metallic pressing member 12 from deflecting.

Accordingly, the fiber optic connector 1 includes the metallic connector housing 10 and the metallic pressing member 12, allowing the fiber optic connector 1 to be used in machines that operate in high-temperature environments. In addition, the fiber optic connector 1 exhibits enhanced structural strength and resists deformation. Further, the metallic pressing member 12 can be directly pressed to unlock the fiber optic adaptor, thereby facilitating user-friendly locking and unlocking operations.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

1. A fiber optic connector, comprising:
a metallic connector housing;
a metallic pressing member assembled with the metallic connector housing; and
an optical fiber unit received and secured to the metallic connector housing; wherein the metallic connector housing comprises an upper portion that defines a mounting space; at least one positioning pillar is disposed in the mounting space; at least one spring member is assembled and positioned on the corresponding positioning pillar; the metallic pressing member is assembled in the mounting space and presses the at least one spring member; the metallic pressing member is provided with at least one locking portion; and when the metallic pressing member is pushed, the at least one locking portion is moved from a first position, in which the fiber optic adaptor is locked to, a second position in which the fiber optic adaptor is unlocked.

2. The fiber optic connector as claimed in claim 1, wherein the mounting space is defined by two short walls and two long walls formed on the upper portion of the metallic connector housing, and the two long walls connect the two short walls.

3. The fiber optic connector as claimed in claim 2, wherein an inner surface of each of the two long walls is formed with at least one guide portion extending toward the metallic pressing member.

4. The fiber optic connector as claimed in claim 3, wherein the metallic pressing member has two sides, each formed with at least one guide slot that aligns with the corresponding guide portion, and the guide slot engages with and constrains the movement of the guide portion.

5. The fiber optic connector as claimed in claim 2, wherein each of the two long walls has a periphery formed with at least one limit groove and at least one opening, and the at least one opening aligns with and allows operation of the at least one locking portion.

6. The fiber optic connector as claimed in claim 5, wherein the metallic pressing member has two sides, each formed with at least one limit piece aligning with the at least one limit groove, and the at least one limit piece is restricted by the at least one limit groove to prevent the metallic pressing member from being detached from the metallic connector housing.

7. A fiber optic connector, comprising:
a metallic connector housing;
a metallic pressing member mounted on the metallic connector housing; and
an optical fiber unit received and mounted on the metallic connector housing; wherein the metallic connector housing comprises an upper portion that defines a mounting space; a plurality of positioning pillars are disposed in the mounting space; a plurality of spring members are mounted and positioned on the corresponding positioning pillar; the metallic pressing member is mounted in the mounting space and presses the plurality of spring members; the metallic pressing member is provided with two locking portions; and when the metallic pressing member is pushed, the two locking portion is moved from an upper position, in which the fiber optic adaptor is locked to, a lower position in which the fiber optic adaptor is unlocked.

8. The fiber optic connector as claimed in claim 7, wherein the mounting space is defined by two short walls and two long walls formed on the upper portion of the metallic connector housing, and the two long walls connect the two short walls.

9. The fiber optic connector as claimed in claim 8, wherein an inner surface of each of the two long walls is formed with at least one guide portion extending toward the metallic pressing member.

10. The fiber optic connector as claimed in claim 9, wherein the metallic pressing member has two sides, each formed with at least one guide slot that aligns with the corresponding guide portion, and the guide slot engages with and constrains the movement of the guide portion.

11. The fiber optic connector as claimed in claim 8, wherein each of the two long walls has a periphery formed with at least one limit groove and at least one opening, and the at least one opening aligns with and allows operation of the at least one locking portion.

12. The fiber optic connector as claimed in claim 11, wherein the two locking portions are respectively positioned above the corresponding openings.

13. The fiber optic connector as claimed in claim 11, wherein the metallic pressing member has two sides, each formed with at least one limit piece aligning with the at least one limit groove, and the at least one limit piece is restricted by the at least one limit groove to prevent the metallic pressing member from being detached from the metallic connector housing.

14. A fiber optic connector, comprising:
a metallic connector housing comprises an upper portion that defines a mounting space, wherein the upper portion of the metallic connector housing defines two openings;
a metallic pressing member assembled with the metallic connector housing; and
an optical fiber unit received and secured to the metallic connector housing; wherein at least one positioning pillar is disposed in the mounting space; at least one spring member is assembled and positioned on the corresponding positioning pillar; the metallic pressing member is assembled in the mounting space and presses the at least one spring member; the metallic pressing member is provided with two locking portion, the two locking portions are respectively located at two lateral sides of the metallic pressing member, the two locking portions are respectively positioned above the corresponding openings, and the two locking portions align with the corresponding openings; and when the metallic pressing member is pushed, the two locking portions are moved into the corresponding openings.

15. The fiber optic connector as claimed in claim 14, wherein the mounting space is defined by two short walls and two long walls formed on the upper portion of the metallic connector housing, and the two long walls connect the two short walls.

16. The fiber optic connector as claimed in claim 15, wherein an inner surface of each of the two long walls is formed with at least one guide portion extending toward the metallic pressing member.

17. The fiber optic connector as claimed in claim 16, wherein the metallic pressing member has two sides, each formed with at least one guide slot that aligns with the corresponding guide portion, and the guide slot engages with and constrains the movement of the guide portion.

18. The fiber optic connector as claimed in claim 15, wherein each of the two long walls has a periphery formed with at least one limit groove and the two openings, and the two openings align with and allow operation of the two locking portions.

19. The fiber optic connector as claimed in claim 18, wherein the metallic pressing member has two sides, each formed with at least one limit piece aligning with the at least one limit groove, and the at least one limit piece is restricted by the at least one limit groove to prevent the metallic pressing member from being detached from the metallic connector housing.
